(19) United States
(12) Patent Application Publication
(10) Pub. No.: US 2023/0385432 A1
(43) Pub. Date: Nov. 30, 2023

(54) CREATING POLICY BASED ON CONFIGURATION CHANGE HISTORY

(71) Applicant: HEWLETT-PACKARD DEVELOPMENT COMPANY, L.P., Spring, TX (US)

(72) Inventors: Youn SEO, Seongnam-si (KR); Gi Won SEO, Seongnam-si (KR); Junghun KIM, Seongnam-si (KR); Byeong Ju HWANG, Seongnam-si (KR); Hyunwoo YOO, Seongnam-si (KR); Sangmi KIM, Seongnam-si (KR); Junhyung YOO, Seongnam-si (KR); Hyungjong KANG, Seongnam-si (KR)

(21) Appl. No.: 17/751,912

(22) Filed: May 24, 2022

(51) Int. Cl. G06F 21/60; G06F 21/62

(52) U.S. Cl. CPC G06F 21/608; G06F 21/62; G06F 2221/2141; G06F 2221/2145

(57) ABSTRACT

An example operating method of an electronic apparatus includes executing, by the electronic apparatus, an application to control an operation of an image forming apparatus, identifying a first image forming apparatus to be connected to the electronic apparatus, and performing a communication connection between the electronic apparatus and the first image forming apparatus, receiving, from the first image forming apparatus, at least one configuration change performed by the first image forming apparatus, and displaying the at least one configuration change, based on the at least one configuration change, receiving a first input to select a first configuration change to at least one image forming apparatus to be controlled by the electronic apparatus, and based on at least one input that is input after the first input, displaying the first configuration change applied to the at least one image forming apparatus.

### BACKGROUND

A user may change a configuration of a device remotely via a cloud service or server, which provides management of applications installed on the device, may transmit, to the device, a command for an application to be installed on or deleted from the device, or may manage a configuration of each application installed on the device.

### BRIEF DESCRIPTION OF THE DRAWINGS

Various examples will be described below by referring to the following figures.

FIG. 1 illustrates a process of creating a policy to be applied to an image forming apparatus via a server according to an example.

FIG. 2 is a flowchart illustrating a method of creating a policy to be applied to an image forming apparatus according to an example.

FIG. 3 illustrates a user interface displaying configuration changes performed by an image forming apparatus according to an example.

FIG. 4 illustrates a user interface through which configuration changes to be applied to a policy may be selected from among configuration changes performed by an image forming apparatus according to an example.

FIG. 5 illustrates a user interface displaying a policy created based on configuration changes selected from among configuration changes performed by an image forming apparatus according to an example.

FIG. 6 illustrates a user interface through which a first time point and a second time point for classifying configuration changes performed by an image forming apparatus may be selected according to an example.

FIG. 7 illustrates a user interface through which a first time point corresponding to a configuration change of a first image forming apparatus and a second time point corresponding to a configuration change of a second image forming apparatus may each be selected according to an example.

FIG. 8 illustrates a process of creating a policy based on a comparison configuration to be compared with a configuration of an image forming apparatus according to an example.

FIG. 9 illustrates a process of creating a policy by applying a restriction on an image forming apparatus according to an example.

FIG. 10 is a flowchart illustrating an operating method of a server according to an example.

### DETAILED DESCRIPTION

In the related art, a user may create a policy by logging in to a remote management server with an administrator or user account. A user may manually create a policy to maintain the same device configurations of devices newly registered to a server via the server or devices that have been previously managed.

Configuration changes for a configuration of a device, applications to be installed on the device, and configurations of applications installed on the device may be created as one policy via a function called dynamic policy. For target devices, the configuration of the device, the applications to be installed, and the configurations of the applications may be set to the same value according to a value defined in the policy. In this case, a user manually inputs values set in one policy, which may be an inconvenience for the user.

In an example, in a cloud service that provides a function to modify or distribute configurations of a remote device, applications to be installed on the device, and a configuration of each application, a configuration of a remote device, applications to be installed on the device, and a configuration of each application may be created as a policy. In an example, in creating and dynamically applying a policy for maintaining a plurality of remote devices with the same configuration and applications, the policy may be easily created automatically without manually inputting each configuration of the policy and may be distributed to the plurality of devices, thereby maintaining the devices with the same configuration.

Hereinafter, with reference to the accompanying drawings, examples will be described. However, the present disclosure may be implemented in several different forms and is not limited to the examples described herein.

The term “electronic apparatus” may refer to an apparatus to manage an image forming apparatus. A management program used to manage the image forming apparatus may be installed on the electronic apparatus. For example, the electronic apparatus may perform at least one operation among registering the apparatus, changing a configuration of the apparatus, installing an application on the apparatus, distributing configuration data of an application, etc., based on information input from the management program via a server. For example, the electronic apparatus may be a mobile terminal apparatus, such as a smartphone, or the like.

The term “policy” may refer to a configuration to provide at least one service among managing the apparatus, changing a configuration of the apparatus, installing an application on the apparatus, distributing configuration data of an application, etc. Also, the image forming apparatus may be connected to a network to change a configuration, according to the policy.

The term “image forming apparatus” may refer to an apparatus to which a policy is to be applied or an apparatus to which a policy application is not completed. The image forming apparatus may execute an application that performs a policy application. The image forming apparatus may obtain policy information from a server by using an application and perform at least one service among managing the image forming apparatus, changing a configuration of the image forming apparatus, installing an application on the image forming apparatus, distributing configuration data of an application, etc.

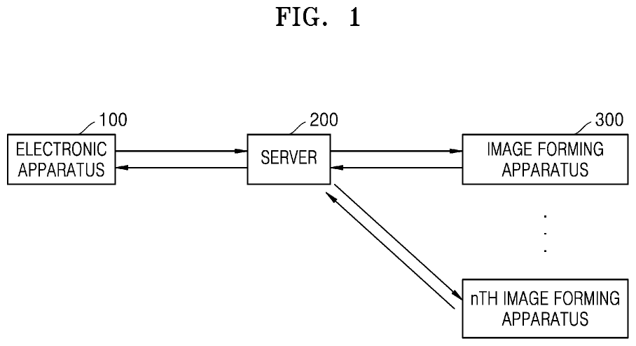

FIG. 1 illustrates a process of an electronic apparatus 100 to create a policy to be applied to an image forming apparatus 300 via a server 200 according to an example.

Referring to FIG. 1, the image forming apparatus 300 may be connected to the server 200 and a network. Also, the electronic apparatus 100 may be connected to the server 200 and the network. In FIG. 1, a plurality of image forming apparatuses, one server, and one electronic apparatus are connected to the network. However, in other examples, a plurality of servers and/or a plurality of electronic apparatuses may be connected to the network.

The image forming apparatus 300 may identify the electronic apparatus 100 that is to control the image forming apparatus 300. For example, the electronic apparatus 100 that is to control the image forming apparatus 300 may create a policy to be applied to the image forming apparatus 300 via the server 200. In an example, the electronic apparatus 100 may create the policy via a remote task history of the image forming apparatus 300. In another example, the electronic apparatus 100 may create the policy via comparison between the plurality of image forming apparatuses or between the image forming apparatus 300 and the policy. For example, as part of creating the policy, the electronic apparatus 100 may select the image forming apparatus 300 subjected to the creating of the policy.

The image forming apparatus 300 may create a configuration change list including at least one configuration change performed by the image forming apparatus 300. For example, the electronic apparatus 100 may perform a task, such as a change of a configuration of the image forming apparatus 300, an installation of an application, a change of configuration data of an installed application, etc., via the server 200. In this case, the image forming apparatus 300 may create a task list including tasks performed by the image forming apparatus 300. In an example, the tasks performed by the image forming apparatus 300 may indicate at least one configuration change including a change of a configuration of the image forming apparatus 300, an installation of an application, a change of configuration data of an installed application, etc. Also, the task list may indicate a configuration change list including at least one configuration change.

The image forming apparatus 300 may transmit the configuration change list to the electronic apparatus 100 via a communication unit. For example, the image forming apparatus 300 may create a configuration change list including at least one configuration change performed by the image forming apparatus 300 and may transmit the created configuration change list to the electronic apparatus 100 via the server 200.

The image forming apparatus 300 may receive, from the electronic apparatus 100, a first configuration change applied, based on the configuration change list, to at least one image forming apparatus, via the communication unit. Also, the image forming apparatus 300 may change a configuration according to the first configuration change. For example, the image forming apparatus 300 may receive a first configuration change from the electronic apparatus 100 to change a configuration of the image forming apparatus 300 or an application installed on the image forming apparatus 300, according to the first configuration change. In this case, the electronic apparatus 100 may create the first configuration change based on a configuration change selected from the configuration change list via the server 200.

The image forming apparatus 300 may be an apparatus that changes a configuration by a policy application. Also, an application may be installed on the image forming apparatus 300. For example, based on an application being executed, the application may collect information about a configuration of the image forming apparatus 300. For example, the image forming apparatus 300 may be any type of apparatus capable of performing an image forming task, such as a printer, a copier, a scanner, a fax machine, a multi-function printer (MFP), a display apparatus, etc. Also, the image forming apparatus 300 may be a two-dimensional (2D) image forming apparatus or a three-dimensional (3D) image forming apparatus. The image forming task performed by the image forming apparatus 300 may be a task related to printing, copying, scanning, faxing, storing, transmitting, coating, etc., or may be a task of a combination of two or more thereof.

The image forming apparatus 300 may include a communication unit, a user interface unit, a memory, a processor, and other components. Hereinafter, examples of the foregoing components are described.

The communication unit may include a communication module (i.e., a transceiver) that supports at least one of various wired/wireless communication methods. For example, the communication module may be in the form of a chipset, or may be a sticker/barcode (e.g., a sticker including a near field communication (NFC) tag) including information used for communication. Also, the communication module may be an NFC module or a wireless communication module.

For example, the communication unit may support at least one of a wireless local area network (wireless LAN), wireless fidelity (Wi-Fi), Wi-Fi direct (WFD), Bluetooth, Bluetooth Low Energy (BLE), a wired LAN, NFC, Zigbee, infrared data association (IrDA), 3^{rd} generation (3G), 4^{th} generation (4G), 5^{th} generation (5G), etc.

The user interface unit may include an input unit to receive an input to control an operation of the image forming apparatus 300 from a user, and an output unit to display information, such as a result, according to the operation of the image forming apparatus 300, a state of the image forming apparatus 300, etc. For example, the user interface unit may include an operation panel to receive a user input and a display panel to display a screen.

In various examples, the input unit may include an apparatus capable of receiving various types of user inputs, such as a keyboard, a physical button, a touchscreen, a camera, a microphone, etc. Also, the output unit may include, for example, a display panel, a speaker, etc. However, examples are not limited thereto, and the user interface unit may include an apparatus that supports various inputs/outputs.

The memory may store machine readable instructions or a program. Hereinafter, examples of the machine readable instructions or the program may include machine readable instructions or a program, which is used by an electronic device, such as the electronic apparatus 100, the server 200, or the image forming apparatus 300. For example, the memory may store instructions for an operating method of the image forming apparatus 300.

The processor may control an operation of the image forming apparatus 300 and may include at least one processor, such as a central processing unit (CPU). The processor may include at least one processor specialized for each function or may be an integrated processor. For example, the processor may include a policy application module to perform an operation for a policy application. For example, the processor may call at least one application programming interface (API) used to perform an operation for a policy application.

Examples of the electronic apparatus 100 and the server 200 are described below.

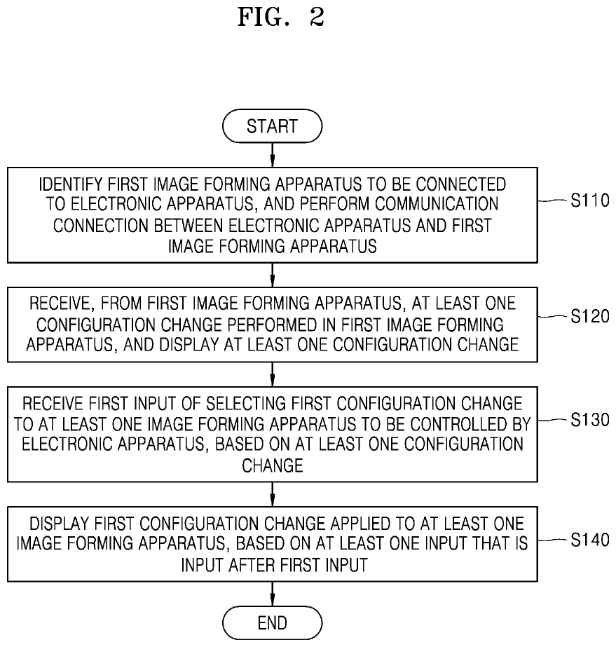

FIG. 2 is a flowchart illustrating a method of creating a policy to be applied to the image forming apparatus 300 according to an example.

Referring to FIG. 2, the electronic apparatus 100 may execute an application to control an operation of the image forming apparatus 300 in operation S110. Also, the electronic apparatus 100 may identify the image forming apparatus 300 to be connected to the electronic apparatus 100 and may perform a communication connection between the electronic apparatus 100 and the image forming apparatus 300.

In operation S120, the electronic apparatus 100 may receive, from the image forming apparatus 300, at least one configuration change performed by the image forming apparatus 300, and may display the at least one configuration change. For example, the electronic apparatus 100 may receive at least one configuration change including a task, such as a configuration change performed by the image forming apparatus 300, an installation of an application, a change of configuration data of an installed application, etc., via the server 200. Also, the electronic apparatus 100 may display the at least one configuration change via a user interface.

In operation S130, the electronic apparatus 100 may receive a first input to select a first configuration change to at least one image forming apparatus controlled by the electronic apparatus 100, based on the at least one configuration change. For example, the electronic apparatus 100 may receive a first input to select a first configuration change applied to at least one image forming apparatus from among at least one configuration change via a user interface. For example, the first configuration change may indicate a configuration change selected from a configuration change list.

In operation S140, the electronic apparatus 100 may display the first configuration change applied to the at least one image forming apparatus, based on at least one input that is input after the first input.

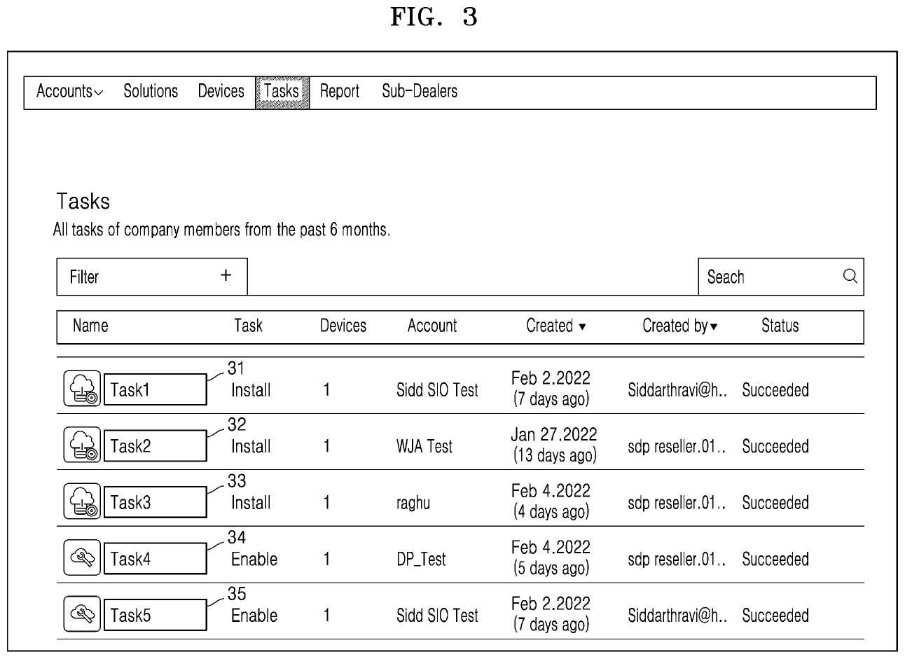

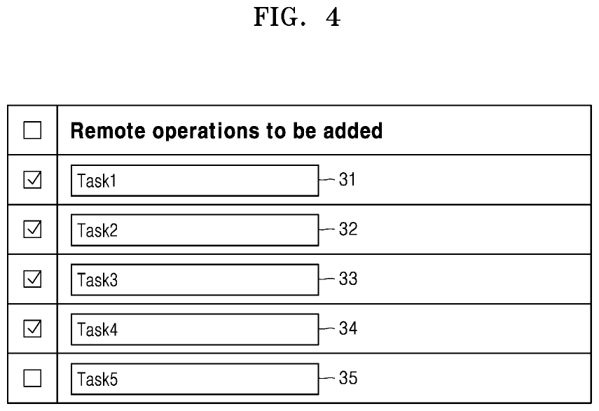

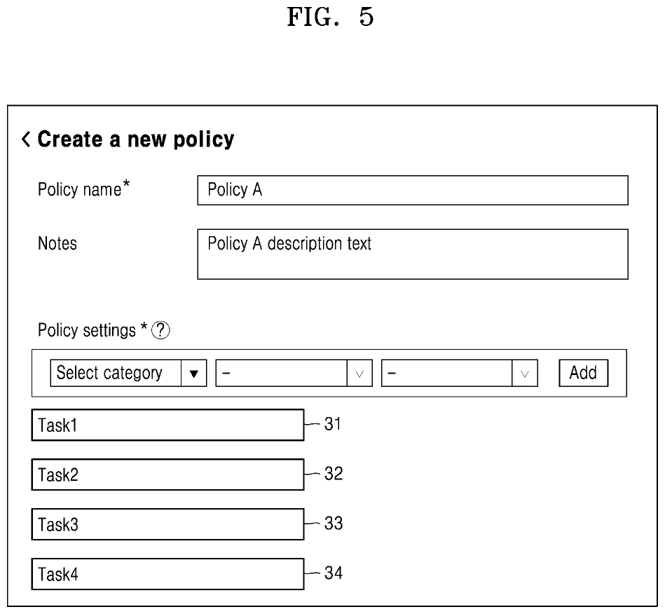

FIG. 3 illustrates a user interface displaying configuration changes performed by the image forming apparatus 300 according to an example. FIG. 4 illustrates a user interface through which configuration changes to be applied to a policy may be selected from among configuration changes performed by the image forming apparatus 300 according to an example. FIG. 5 illustrates a user interface displaying a policy created based on configuration changes selected from among configuration changes performed by the image forming apparatus 300 according to an example.

Referring to FIGS. 3 to 5, in an example, for one image forming apparatus 300 selected by a user via the electronic apparatus 100, a policy may be created by comparing configuration changes of the image forming apparatus 300 between two time points.

For example, a policy may be created by comparing configuration changes applied to the image forming apparatus 300 from a first time point immediately after onboarding the one image forming apparatus 300 to a second time point after a specific time. For example, the first time point and the second time point to be compared may be preset or may be input by a user via the electronic apparatus 100.

The electronic apparatus 100 may receive an input to select a first time point and a second time point for time-sequentially classifying at least one configuration change performed by the image forming apparatus 300. In an example, the first configuration change may be created based on the at least one configuration change between the first time point and the second time point.

For a first time point and a second time point for time-sequentially classifying the at least one configuration change performed by the image forming apparatus 300, the server 200 may create the first configuration change based on the at least one configuration change between the first time point and the second time point. For example, the server 200 may create a policy based on at least one configuration change performed from immediately after the image forming apparatus 300 is registered with the server 200 to a current time point.

For example, as shown in FIG. 3, the electronic apparatus 100 may display configuration changes 31, 32, 33, 34, and 35 performed by the image forming apparatus 300 between a first time point and a second time point via the user interface. For example, the configuration changes 31, 32, 33, 34, and 35 may include a change of a configuration of the image forming apparatus 300, an installation of an application on the image forming apparatus 300, a change of a configuration of an application installed on the image forming apparatus 300, etc.

As shown in FIG. 4, the electronic apparatus 100 may receive an input to select the configuration changes 31, 32, 33, and 34 to be included in the policy from among the configuration changes 31, 32, 33, 34, and 35 via the user interface.

As shown in FIG. 5, the electronic apparatus 100 may display a first configuration change including the configuration changes 31, 32, 33, and 34 to be included in the policy via the user interface. In this case, the server 200 may create the first configuration change based on the configuration changes 31, 32, 33, and 34 to be included in the policy. In this regard, the first configuration change may indicate the policy.

For a first time point and a second time point for time-sequentially classifying the at least one configuration change performed by the image forming apparatus 300, the image forming apparatus 300 may receive the first configuration change created based on the at least one configuration change between the first time point and the second time point. For example, the image forming apparatus 300 may perform a task, such as a change of a configuration of the image forming apparatus 300, an installation of an application on the image forming apparatus 300, a change of a configuration of an application installed on the image forming apparatus 300, etc. based on the configuration changes 31, 32, 33, and 34 included in the received first configuration change.

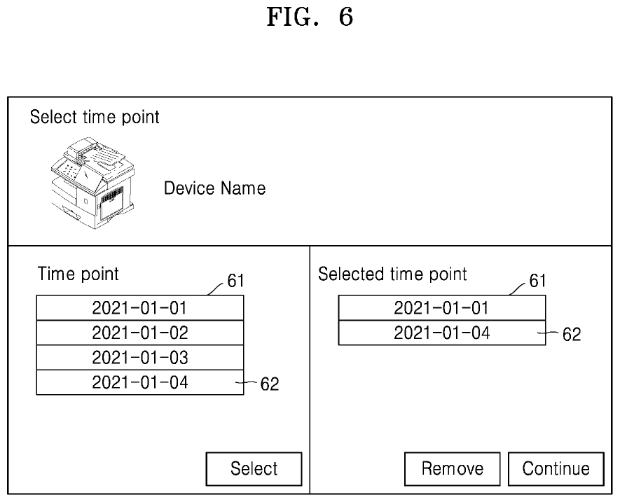

FIG. 6 illustrates a user interface through which a first time point and a second time point for classifying configuration changes performed by the image forming apparatus 300 may be selected according to an example.

Referring to FIG. 6, the electronic apparatus 100 may provide a screen through which a user may select a comparison time point for creating a policy via the user interface. For example, as shown in FIG. 6, based on a user selecting two time points 61 and 62 to be compared, the server 200 may identify configuration changes performed by the image forming apparatus 300 between the two time points 61 and 62 and may create a new policy based on the configuration changes between the two identified time points 61 and 62. In an example, the user may modify or delete each of configurations of the newly created policy. In an example, based on a user confirmation of the newly created policy being completed, the server 200 may apply the policy to other image forming apparatuses than the image forming apparatus 300.

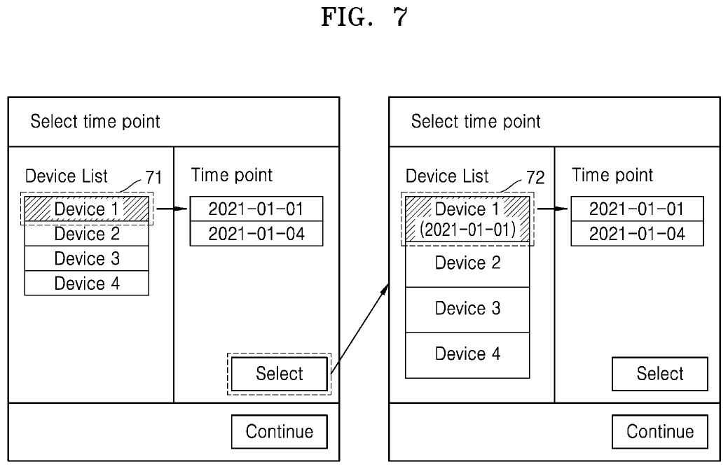

FIG. 7 illustrates a user interface through which a first time point corresponding to a configuration change of a first image forming apparatus and a second time point corresponding to a configuration change of a second image forming apparatus may each be selected according to an example.

Referring to FIG. 7, in an example, a policy may be created by comparing configurations of a plurality of image forming apparatuses.

In an example, a user may access the server 200 via the electronic apparatus 100 and select N image forming apparatuses of which configurations are to be compared. In this case, the electronic apparatus 100 may display selectable time points of each image forming apparatus via the user interface. For example, as shown in FIG. 7, the electronic apparatus 100 may display selectable time points of a first image forming apparatus device 1, a second image forming apparatus device 2, a third image forming apparatus device 3, and a fourth image forming apparatus device 4.

In an example, based on a user selecting a time point to be compared of each image forming apparatus via the electronic apparatus 100, the server 200 may create a new policy by comparing configurations of the selected time points of the image forming apparatus. For example, as shown in FIG. 7, based on a user selecting a comparison time point of the first image forming apparatus device 1 via the electronic apparatus 100 (operation 71), the electronic apparatus 100 may display the selected comparison time point of the first image forming apparatus device 1 (operation 72).

In an example, a user may modify or delete each of configurations of a newly created policy via the electronic apparatus 100. In an example, based on a user confirmation being completed, the server 200 may apply the newly created policy to at least one image forming apparatus. In an example, configurations that conflict in a policy created by the server 200 may be addressed according to a priority for each image forming apparatus designated by a user, or may be directly selected in the process of user confirmation.

For a first time point corresponding to at least one configuration change of a first image forming apparatus and a second time point corresponding to at least one configuration change of a second image forming apparatus, the image forming apparatus 300 may receive a first configuration change created based on a configuration of the first image forming apparatus at the first time point and a configuration of the second image forming apparatus at the second time point.

The electronic apparatus 100 may receive an input to select a second image forming apparatus to be compared with a first image forming apparatus. The electronic apparatus 100 may receive an input to select a first time point corresponding to at least one configuration change of the first image forming apparatus and receive an input to select a second time point corresponding to at least one configuration change of the second image forming apparatus. In this regard, the first configuration change may be created based on a configuration of the first image forming apparatus at the first time point and a configuration of the second image forming apparatus at the second time point.

For a first time point corresponding to at least one configuration change of a first image forming apparatus and a second time point corresponding to at least one configuration change of a second image forming apparatus, the server 200 may create a first configuration change based on a configuration of the first image forming apparatus at the first time point and a configuration of the second image forming apparatus at the second time point.

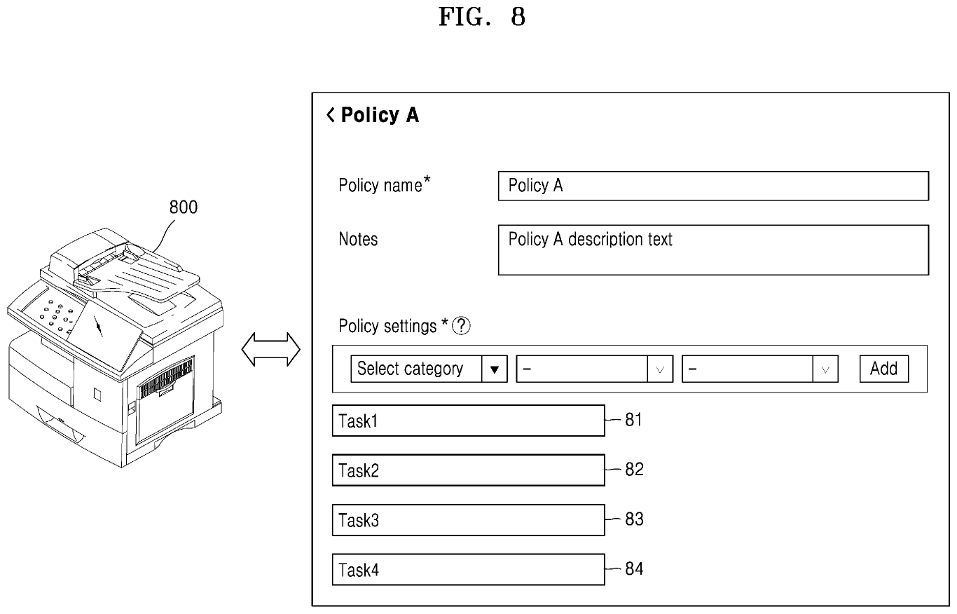

FIG. 8 illustrates a process of creating a policy based on a comparison configuration to be compared with a configuration of the image forming apparatus 300 according to an example.

Referring to FIG. 8, in an example, a policy may be created by comparing a configuration of the image forming apparatus 300 to a configuration of a specific policy.

In an example, as shown in FIG. 8, a user may access the server 200 via the electronic apparatus 100 to select an image forming apparatus 800 to be compared and to select a policy (e.g., Policy A). For example, any number of each of the image forming apparatus 800 to be compared and the policy may be selected. For example, the electronic apparatus 100 may display selectable time points of the image forming apparatus 800 to be compared.

In an example, based on a user selecting a comparison time point of the image forming apparatus 800 to be compared via the electronic apparatus 100, the server 200 may create a new policy by comparing a configuration of the comparison time point of the image forming apparatus 800 to be compared to configurations 81, 82, 83, and 84 of the policy.

In an example, a user may modify or delete each of configurations of a newly created policy via the electronic apparatus 100. In an example, based on a user confirmation being completed, the server 200 may apply the newly created policy to at least one image forming apparatus. In an example, configurations that conflict based on the server 200 creating a policy may be addressed according to a priority for an image forming apparatus designated by a user or a policy, or each of the configurations may be directly selected in the process of user confirmation.

For a first time point corresponding to a configuration of a first image forming apparatus, the image forming apparatus 300 may receive a first configuration change created based on the configuration of the first image forming apparatus at the first time point and at least one comparison configuration to be compared with the configuration of the first image forming apparatus.

The electronic apparatus 100 may receive an input to select at least one comparison configuration to be compared with a configuration of a first image forming apparatus. The electronic apparatus 100 may receive an input to select a first time point corresponding to the configuration of the first image forming apparatus. In this regard, the first configuration change may be created based on the configuration of the first image forming apparatus at the first time point and the at least one comparison configuration.

For a first time point corresponding to a configuration of a first image forming apparatus, the server 200 may create a first configuration change based on the configuration of the first image forming apparatus at the first time point and at least one comparison configuration to be compared with the configuration of the first image forming apparatus.

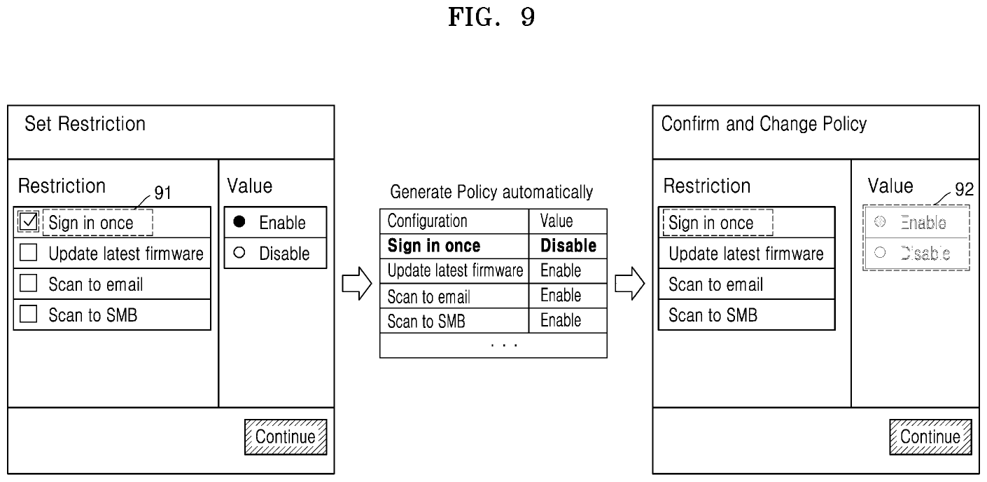

FIG. 9 illustrates a process of creating a policy by applying a restriction on the image forming apparatus 300 according to an example.

Referring to FIG. 9, in an example, a policy may be created considering a restriction on the image forming apparatus 300. For example, the restriction may include a restriction on an automatic firmware update, a restriction on setting of sign in once, a restriction on installation of a specific application, etc. In an example, the restriction may be preset or may be input by a user (operation 91). In an example, a user may preset a restriction to be applied based on a policy being created via the electronic apparatus 100.

In an example, based on automatically creating a policy, the server 200 may apply a preset restriction after performing the above-described examples (e.g., creating a policy by comparing configuration changes of an image forming apparatus between two time points in FIGS. 3 to 6, creating a policy by comparing configurations of a plurality of image forming apparatuses in FIG. 7, or creating a policy by comparing a configuration of an image forming apparatus to a configuration of a specific policy in FIG. 8). In this case, the configuration may be deleted from the created policy or may be changed.

In an example, the electronic apparatus 100 may display a newly created policy after applying a restriction. In an example, a user may modify or delete each of configurations of a newly created policy via the electronic apparatus 100. In this case, configurations to which the restriction is applied may not be deleted or modified (operation 92). In an example, based on a user confirmation being completed, the server 200 may apply the newly created policy to at least one image forming apparatus.

The electronic apparatus 100 may receive an input for a preset restriction on a first image forming apparatus. In this regard, the first configuration change may be created based on the preset restriction.

The image forming apparatus 300 may receive a first configuration change created based on information about a preset restriction on a first image forming apparatus.

The server 200 may create a first configuration change based on information about a preset restriction on a first image forming apparatus.

The electronic apparatus 100 may include a communication unit, a user interface unit, a memory, a processor, and other components. Hereinafter, examples of the above-described components are described.

The communication unit may include a communication module (i.e., a transceiver) that supports at least one of various wired/wireless communication methods. For example, the communication module may be in the form of a chipset, or may be a sticker/barcode (e.g., a sticker including an NFC tag) including information used for communication. Also, the communication module may be an NFC module or a wireless communication module.

For example, the communication unit may support at least one of a wireless LAN, Wi-Fi, WFD, Bluetooth, BLE, a wired LAN, NFC, Zigbee, IrDA, 3G, 4G, 5G, etc.

The user interface unit may include an input unit to receive an input to control an operation of the electronic apparatus 100 from a user, and an output unit to display information, such as a result, according to the operation of the electronic apparatus 100, a state of the electronic apparatus 100, etc. For example, the user interface unit may include an operation panel to receive a user input and a display panel that displays a screen.

In various examples, the input unit may include an apparatus capable of receiving various types of user inputs, such as a keyboard, a physical button, a touchscreen, a camera, a microphone, etc. Also, the output unit may include, for example, a display panel, a speaker, etc. However, examples are not limited thereto, and the user interface unit may include an apparatus that supports various inputs/outputs.

The memory may store machine readable instructions or a program. For example, the memory may store instructions for an operating method of the electronic apparatus 100 that creates a policy via the server 200.

The memory may include at least one type of storage medium among a flash memory type, a hard disk type, a multimedia card micro type, a card-type memory (for example, a secure digital (SD) or extreme digital (xD) memory), random access memory (RAM) static random access memory (SRAM), read-only memory (ROM), electrically erasable programmable read-only memory (EEPROM), programmable read-only memory (PROM), magnetic memory, a magnetic disk, an optical disk, etc.

The processor may control an operation of the electronic apparatus 100 and may include at least one processor, such as a CPU. The processor may include at least one processor specialized for each function, or may be an integrated processor.

The processor may execute a program stored in the memory, may read data or a file stored in the memory, or may store new data or a new file in the memory. The processor may perform an operation of the electronic apparatus 100 by executing instructions stored in the memory.

The server 200 may provide information requested from the image forming apparatus 300 and the electronic apparatus 100 and may create a policy to be applied to the image forming apparatus 300, based on information received from the image forming apparatus 300 and the electronic apparatus 100.

For example, the server 200 may perform at least one operation among an operation of transmitting a task requested from the server 200 and an operation of obtaining a result of performing the task from the apparatus. Also, at least one operation among an operation of transmitting a task requested from the server 200 to the apparatus and an operation of transmitting a result of performing the task from the apparatus to the server 200 may also be performed in an external apparatus that is independently separated from the server 200.

The server 200 may include a communication unit, a memory, a processor, and other components. The server 200 may be implemented as a plurality of servers including a cloud server and a portal server. Hereinafter, examples of the above-described components are described.

The communication unit may include a communication module (e.g., a transceiver) that supports at least one of various wired/wireless communication methods. For example, the communication module may be in the form of a chipset, or may be a sticker/barcode (e.g., a sticker including an NFC tag) including information used for communication. Also, the communication module may be an NFC module or a wireless communication module. For example, the communication unit may communicate with the electronic apparatus 100 and the image forming apparatus 300.

For example, the communication unit may support at least one of a wireless LAN, Wi-Fi, WFD, Bluetooth, BLE, a wired LAN, NFC, Zigbee, IrDA, 3G, 4G, 5G, etc.

The memory may store machine readable instructions or a program. For example, the memory may store instructions for an operating method of the server 200 that creates a policy.

The processor may control an operation of the server 200 and may include at least one processor, such as a CPU. The processor may include at least one processor specialized for each function or may be an integrated processor.

The processor may execute a program stored in the memory, may read data or a file stored in the memory, or may store new data or a new file in the memory. For example, the processor may include a policy creation module that performs an operation for policy creation. For example, the processor may call at least one API used to perform an operation for policy creation.

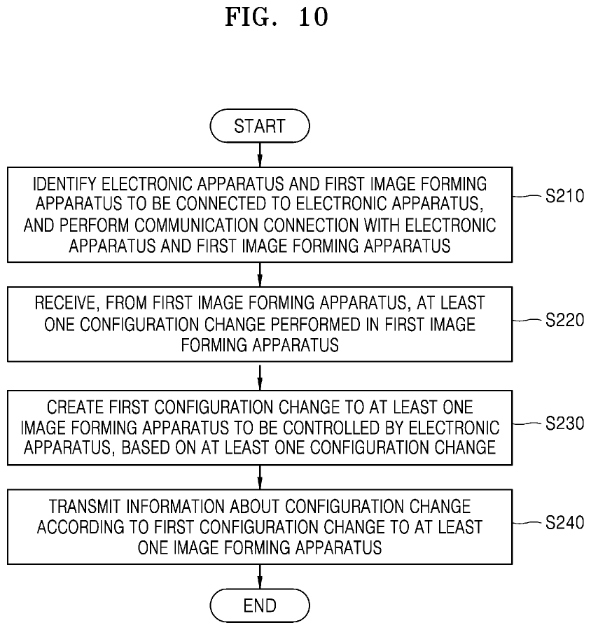

FIG. 10 is a flowchart illustrating an operating method of the server 200 according to an example.

Referring to FIG. 10, the server 200 may identify the electronic apparatus 100 and the image forming apparatus 300 to be connected to the electronic apparatus 100 and may perform a communication connection with the electronic apparatus 100 and the image forming apparatus 300 in operation S210.

In operation S220, the server 200 may receive, from the image forming apparatus 300, at least one configuration change performed by the image forming apparatus 300.

In operation S230, the server 200 may create a first configuration change to at least one image forming apparatus to be controlled by the electronic apparatus 100, based on the at least one configuration change.

In operation S240, the server 200 may transmit information about a configuration change according to the first configuration change to the at least one image forming apparatus.

In an example, based on the server 200 applying a policy to image forming apparatuses via a dynamic policy (or policy), other than a method of manually inputting configurations to the policy, the policy may be easily created by comparing configurations of two different time points of one image forming apparatus, comparing configurations of a plurality of image forming apparatus, or comparing configurations of an image forming apparatus and a policy, and the policy may be distributed to a plurality of target image forming apparatuses.

In addition, operating methods of the electronic apparatus 100, the server 200, and the image forming apparatus 300 may be implemented in the form of a non-transitory computer-readable storage medium storing instructions or data executable by a computer or a processor. The operating methods may be written as a program executable by a computer, and may be implemented in a general-purpose digital computer that executes such a program using a non-transitory computer-readable storage medium. The non-transitory computer-readable storage medium may be ROM, RAM, flash memory, compact disc (CD)-ROMs, CD-recordables (Rs), CD+ Rs, CD-rewriteables (RWs), CD+RWs, digital versatile disk (DVD)-ROMs, DVD-Rs, DVD+Rs, DVD-RWs, DVD+RWs, DVD-RAMs, Blu-ray disc (BD)-ROM, BD-Rs, BD-R low to high (LTH) discs, BD-recordable erasable (RE) discs, magnetic tapes, floppy disks, magneto-optical data storage devices, optical data storage devices, hard disks, or solid-state disks (SSDs), may store machine readable instructions, related data, data files, and data structures, and may be any device capable of providing machine readable instructions, related data, data files, and data structures to a processor or computer so that the processor or computer may execute the instructions.

Various modifications and variations are possible from the above description. For example, the described techniques may be performed in an order different from the described method, and/or the described components such as a system, a structure, an apparatus, a circuit, etc. may be attached or combined in a different form than the described method or replaced or substituted by other components or equivalents, to achieve an appropriate result.

Examples described herein should be considered in a descriptive sense and not for purposes of limitation. Descriptions of features or aspects within each example should typically be considered as available for other similar features or aspects in other examples. While examples have been described with reference to the figures, it will be understood that various changes in form and details may be made therein without departing from the spirit and scope as defined by the following claims.

What is claimed is:

1. An operating method of an electronic apparatus, the operating method comprising:
executing, by the electronic apparatus, an application to control an operation of an image forming apparatus;
identifying a first image forming apparatus to be connected to the electronic apparatus and performing a communication connection between the electronic apparatus and the first image forming apparatus;
receiving, from the first image forming apparatus, at least one configuration change performed by the first image forming apparatus and displaying the at least one configuration change;
based on the at least one configuration change, receiving a first input to select a first configuration change to at least one image forming apparatus to be controlled by the electronic apparatus; and
based on at least one input that is input after the first input, displaying the first configuration change applied to the at least one image forming apparatus.

2. The operating method of claim 1,
wherein the displaying of the at least one configuration change comprises receiving an input to select a first time point and a second time point for time-sequentially classifying the at least one configuration change performed in the first image forming apparatus, and
wherein the first configuration change is created based on the at least one configuration change between the first time point and the second time point.

3. The operating method of claim 1, further comprising:
receiving an input to select a second image forming apparatus to be compared with the first image forming apparatus; and
receiving an input to select a first time point corresponding to the at least one configuration change of the first image forming apparatus and receiving an input to select a second time point corresponding to at least one configuration change of the second image forming apparatus,
wherein the first configuration change is created based on a configuration of the first image forming apparatus at the first time point and a configuration of the second image forming apparatus at the second time point.

4. The operating method of claim 1, further comprising:
receiving an input to select at least one comparison configuration to be compared with a configuration of the first image forming apparatus; and
receiving an input to select a first time point corresponding to the configuration of the first image forming apparatus,
wherein the first configuration change is created based on the configuration of the first image forming apparatus at the first time point and the at least one comparison configuration.

5. The operating method of claim 1,
wherein the displaying of the at least one configuration change comprises receiving an input of a preset restriction on the first image forming apparatus, and
wherein the first configuration change is created based on the preset restriction.

6. A non-transitory computer-readable recording medium comprising instructions executable by a processor, wherein the non-transitory computer-readable recording medium comprises:
instructions to perform a communication connection with a first image forming apparatus,
instructions to receive, from the first image forming apparatus, at least one configuration change performed by the first image forming apparatus,
instructions to, based on the at least one configuration change, create a first configuration change to at least one image forming apparatus to be controlled by an electronic apparatus, and
instructions to transmit information about a configuration change according to the first configuration change to the at least one image forming apparatus.

7. The recording medium of claim 6, further comprising instructions to create, for a first time point and a second time point for time-sequentially classifying the at least one configuration change performed in the first image forming apparatus, the first configuration change based on the at least one configuration change between the first time point and the second time point.

8. The recording medium of claim 6, further comprising instructions to create, for a first time point corresponding to the at least one configuration change of the first image forming apparatus and a second time point corresponding to at least one configuration change of a second image forming apparatus, the first configuration change based on a configuration of the first image forming apparatus at the first time point and a configuration of the second image forming apparatus at the second time point.

9. The recording medium of claim 6, further comprising instructions to create, for a first time point corresponding to a configuration of the first image forming apparatus, the first configuration change based on the configuration of the first image forming apparatus at the first time point and at least one comparison configuration to be compared with the configuration of the first image forming apparatus.

10. The recording medium of claim 6, further comprising instructions to create the first configuration change based on information about a preset restriction on the first image forming apparatus.

11. An image forming apparatus comprising:
a communication unit to communicate with an external apparatus;
a processor to control an operation of an image forming apparatus; and
a memory to store instructions executable by the processor, wherein the processor executes the instructions to:
create a configuration change list including at least one configuration change performed by the image forming apparatus, and transmit the configuration change list to an electronic apparatus via the communication unit,
receive, from the electronic apparatus, a first configuration change based on the configuration change list via the communication unit, and
change a configuration according to the first configuration change.

12. The image forming apparatus of claim 11, wherein the processor executes the instructions to receive, for a first time point and a second time point for time-sequentially classifying the at least one configuration change performed by the image forming apparatus, the first configuration change created based on the at least one configuration change between the first time point and the second time point.

13. The image forming apparatus of claim 11, wherein the processor executes the instructions to receive, for a first time point corresponding to the at least one configuration change of the image forming apparatus and a second time point corresponding to at least one configuration change of a second image forming apparatus, the first configuration change created based on a configuration of the image forming apparatus at the first time point and a configuration of the second image forming apparatus at the second time point.

14. The image forming apparatus of claim 11, wherein the processor executes the instructions to receive, for a first time point corresponding to a configuration of the image forming apparatus, the first configuration change created based on the configuration of the image forming apparatus at the first time point and at least one comparison configuration to be compared with the configuration of the image forming apparatus.

15. The image forming apparatus of claim 11, wherein the processor executes the instructions to receive the first configuration change created based on information about a preset restriction on the image forming apparatus.
